(19) United States
(12) Patent Application Publication
(10) Pub. No.: US 2009/0282468 A1
(43) Pub. Date: Nov. 12, 2009

(54) Systems and methods of network operation and information processing, including use of persistent/anonymous identifiers throughout all stages of information processing and delivery

(75) Inventors: Jasminder Banga, San Francisco, CA (US); Nitin Shah, Cupertino, CA (US); Miten Sampat, San Francisco, CA (US)

Correspondence Address: COURTNEY STANIFORD & GREGORY LLP, 10001 N. De Anza Blvd., Suite 300, Cupertino, CA, 95014, US

(73) Assignee: Feeva Technology Inc., San Francisco, CA (US)

(21) Appl. No.: 11/985,860

(22) Filed: Nov. 15, 2007

Related U.S. Application Data
(60) Provisional application No. 60/878,352, filed on Jan. 4, 2007.

(51) Int. Cl. G06F 7/04

(52) U.S. Cl. 726/8; 726/5

(57) ABSTRACT

Systems and methods are disclosed for network operation and information processing associated with global unique identifiers (GUIDs). In one exemplary embodiment, there is provided a method of inserting a UID into a web-bound request. Moreover, the method includes, in the context of processing a web-bound request associated with a browsing session, extracting non-personal/device information during MAC/network layer processing, processing an anonymous UID created based on the non-personal/device information, and inserting the UID in the HTTP header or other extensible locations within the web-bound request. Exemplary embodiments may also include enabling global persistence of the UID as a function of extraction of non-personal/device data during MAC/network layer processing.

### CROSS REFERENCE TO RELATED APPLICATIONS

This application claims the benefit of U.S. provisional application No. 60/878,352, initially filed Nov. 15, 2006, which is incorporated herein by reference in entirety.

### BACKGROUND

1. Field

The present invention relates to information processing associated with global unique identifiers (GUID), and, more particularly, to features consistent with generation, insertion and/or utilization of GUIDs.

2. Description of Related Information Web and other network-related processing typically include processing web-bound requests, such as those associated with a browsing session. Existing systems and methods of processing sometimes include components that obtain valuable information about devices or users of devices that initiated the requests. However, such components generally employ, or at least obtain/process, personally identifiable information (PII) regarding a specific user associated with the request and rely on cookies as a foundation of that information. As such, they are unable to implement intended information processing objectives while also maintaining levels of user privacy compliant with law, public interest and public opinion.

Present methods of delivering content also have drawbacks related to appropriately profiling users or Web use. First, sites can only mark behavior of users that have visited the site. This leads to a rather compartmentalized view of a user based on the site's limited past experience with the user. Next, the user must visit the site that set the marker before it can be read to deliver any targeted content. Finally, with the rapid upsurge and continued growth in mobile computing, user-profile related information stored with such limited marker technologies can quickly become irrelevant or hopelessly inaccurate. For example, geographic location information about a user may change quickly. Thus, displaying an advertisement for a store in New Orleans, La. may be a waste of server resources if the user is currently in Paris, France. On the other hand, the advertising may be extremely effective if the advertising was directed to Cajun or Creole restaurants in Paris, France. Thus, drawbacks are present with regard to any such content delivery methodologies that fail to possess website-independent user-related information that is dynamically updateable and usable in real-time.

To compound the problems facing advertising content deliverers, Internet users are becoming increasingly unreceptive to traditional advertising techniques such as banners or pop-up windows. Thus, advertisers are resorting to more content-rich advertising, where advertising is done more suggestively through content-placement at strategic points in the presentation. Content-rich advertising is effective but demands greater data bandwidth thus leaving less time for content deliverers to process user-profile related information and make real-time targeting decisions. Moreover, with increasing concerns about privacy and data security a large number of users routinely delete cookies and other tracking information stored on their computers making such targeting decisions difficult, if not impossible. As a result, content servers have resorted to a fixed pool of content that is served up to website-users round robin with little or no effort directed at targeting.

Other existing systems may include components (i.e., hardware, software, etc.) that primarily process data in the most readily manipulated contexts, such as in the application layer. Such systems may then enable entities, such as a service providers, to append identifiers like a cookie via application layer processing to learn information about a person accessing the web and their browsing history/habits. A drawback of these systems, however, is that their identifiers may be recycled or deleted by any interested party, antivirus software, user flushing of cookies, privacy software, and thus are incapable of global, persistent existence throughout all phases of network processing and information delivery.

Another drawback of existing systems and methods relates to the use of revenue models/streams for advertising content deliverers that are based on click-through rates by users. In other words, the revenue stream often depends on the number of users responding to an advertisement rather than the raw number of advertisements served to users. Thus, on one hand the untargeted round robin delivery scheme limits the number and types of advertisements within a pool because each advertisement is served to a large number of users. On the other hand, advertisers lose revenue because untargeted advertising will generally result in lower click-through rates.

In sum, there is a need for systems and methods that adequately enable features consistent with generation, insertion and/or utilization of GUIDs by, for example, appropriately extract non-PII information to generate anonymous GUIDs and/or perform related processing using globally persistent identifiers in a manner consistent with maintaining genuine user privacy.

### SUMMARY

Systems, methods, and articles of manufacture consistent with the invention are directed to network operation and information processing associated with global unique identifiers (GUIDs). As set forth herein, various embodiments of such systems, methods, and articles of manufacture are disclosed.

In one exemplary embodiment, there is provided a method of inserting a UID into a web-bound request. Moreover, the method includes, in the context of processing a web-bound request associated with a browsing session, extracting non-personal/device information during MAC/network layer processing, processing an anonymous UID created based on the non-personal/device information, and inserting the UID in the HTTP header or other extensible locations within the web-bound request. Exemplary embodiments may also include enabling global persistence of the UID as a function of extraction of non-personal/device data during MAC/network layer processing.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and sub-combinations of several further features disclosed below in the detailed description.

### BRIEF DESCRIPTION OF THE DRAWINGS

The accompanying drawings, which constitute a part of this specification, illustrate various embodiments and aspects of the present invention and, together with the description, explain the principles of the invention. In the drawings:

FIG. 1 is a block diagram of an exemplary computer system consistent with one or more aspects related to the innovations herein.

FIG. 2 is another block diagram of an exemplary computer system illustrating features and functionality consistent with one or more aspects related to the innovations herein.

FIG. 3 is still another block diagram of an exemplary computer system illustrating features and functionality consistent with one or more aspects related to the innovations herein.

FIG. 4 is a chart illustrating exemplary features and functionality consistent with one or more aspects related to the innovations herein.

FIG. 5 is yet another block diagram of an exemplary computer system illustrating features and functionality consistent with one or more aspects related to the innovations herein.

FIG. 6 is a flow chart illustrating an exemplary process for implementing network operation and information processing, according to one or more embodiments of the present invention.

FIG. 7 is a diagram illustrating exemplary features and functionality consistent with one or more aspects related to the innovations herein.

FIG. 8 is a diagram illustrating an exemplary system consistent with one or more aspects related to the innovations herein.

FIG. 9 is a diagram illustrating an exemplary system and features consistent with one or more aspects related to the innovations herein.

FIG. 10 is a diagram illustrating an exemplary system and features consistent with one or more aspects related to the innovations herein.

### DESCRIPTION OF EXEMPLARY EMBODIMENTS

Reference will now be made in detail to embodiments of the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

Many systems and environments are used in connection with networks, network operation, and associated information processing. These systems and environments can be implemented with a variety of components, including various permutations of the hardware, software, and firmware disclosed below. Exemplary system architecture for the embodiments of systems and methods of network operation and information processing disclosed throughout this specification is set forth as follows.

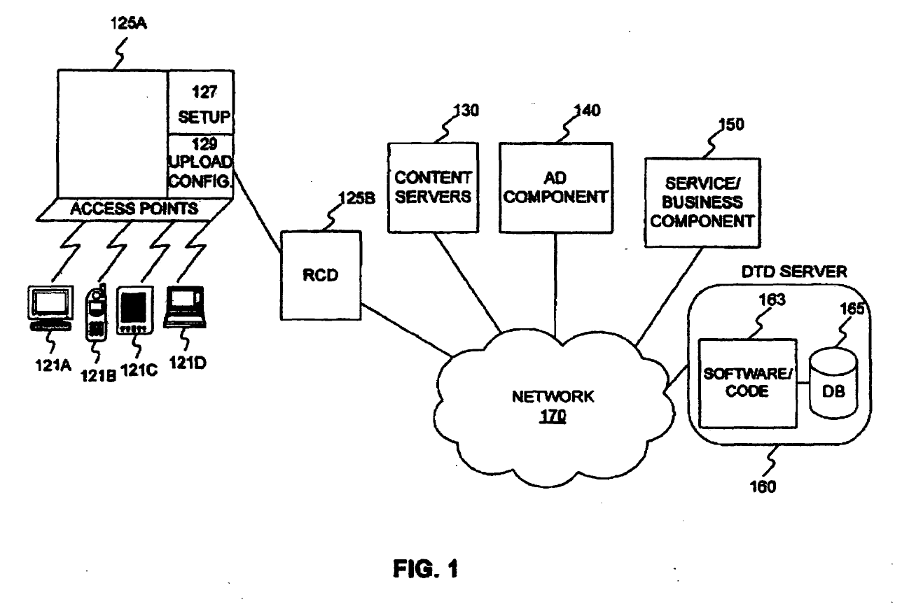

FIG. 1 illustrates a block diagram of an exemplary system consistent with one or more embodiments of the present invention. While the description of FIG. 1 is directed to the following exemplary hardware and software elements, the components of the system can be implemented through any suitable unitary or distributed combination of hardware, software and/or firmware. Referring to FIG. 1, the illustrated system includes access devices 121A-121C, one or more components such as Access and/or Routing/Connectivity Devices (RCDs) 125A and 125B, and other connected or distributed processing components such as a router or network management component 110, variously-implemented GUID components 180A-180C, and another RCD component 130, typically connected via a network 140 such as the World Wide Web. Data processing between the RCDs, the access devices 121A-121C and their users, and the other components, over the network 140, is used to implement various aspects of information and unique identifier (UID) processing disclosed herein. When an internet user/internet-connected-device begins, restarts or continues a browsing session to obtain internet based content, several network connectivity-granting devices within the network initiate operation.

For example, a request, such as from a user of an access device 121A-121C, associated with a browsing session on the network may be transmitted from access devices 121A-121C to a first RCD component 125B. Subsequent communication between the first RCD component 125B and the router or network management component 110 sets the stage for operations of generating a GUID as well as inserting a GUID into a web-bound request, as set forth herein. For example, an exemplary method of generating a global unique identifier associated with web/network-related requests may comprise, in the context of processing a web-bound request associated with a browsing session, receiving information associated with a device that initiated a web-bound request, extracting “non-personal/device information” during MAC/network layer processing, wherein the non-personal/device information includes one or more of data associated with a device/user, data related to the device, software on the device, or any user/input data that is resident on the device, and creating a persistent/anonymous GUID based on the non-personal/device information. Further, enablement of a globally persistent UID correlates as a function of the extraction of non-personal/device data during MAC/network layer processing. Further, methods of inserting a UID into a web-bound request may comprise, in the context of processing a web-bound request associated with a browsing session, extracting non-personal/device information during MAC/network layer processing, creating an anonymous UID based on the non-personal/device information, and inserting the UID in the HTTP header or other extensible locations within the web-bound request. Again, here, enablement of a globally persistent UID correlates as a function of the extraction of non-personal/device data during MAC/network layer processing.

Elements of these operations relate to the process of authentication, authorization, and provisioning of access to the said/content-seeking internet connected device. In some embodiments of this process, the authentication, authorization and provisioning elements in the network may trigger/send messages to the Identification element as described in the current invention. The identification element may use these triggers/messages—that may contain information relevant to the anonymous & persistent identification/re-identification of the content seeking device—to create novel and persistent-anonymous-globally unique identifiers (Persistent & Anonymous GUID's). Elements of these triggers/messages, obtained by the Identification element, contain information prevalent at Layers 2 & 3 of the OSI (Open Systems Interconnection) Stack of network processing.

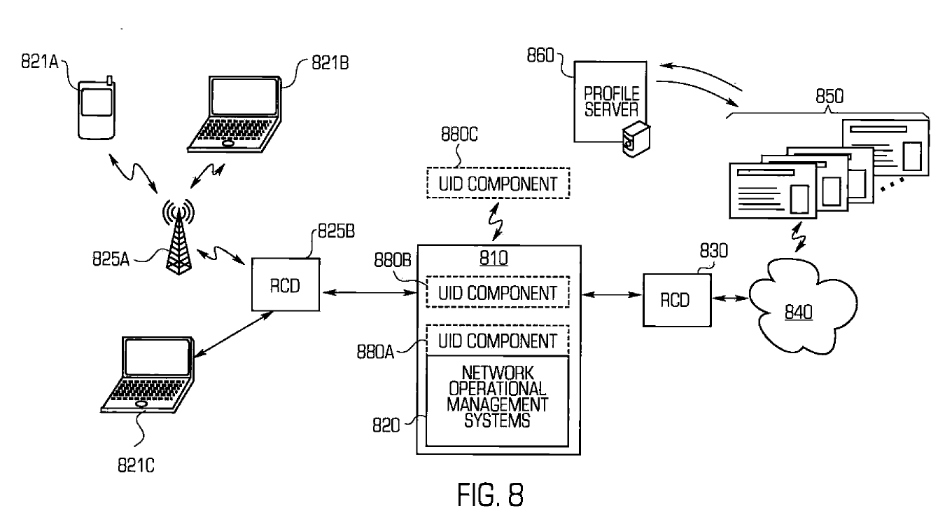

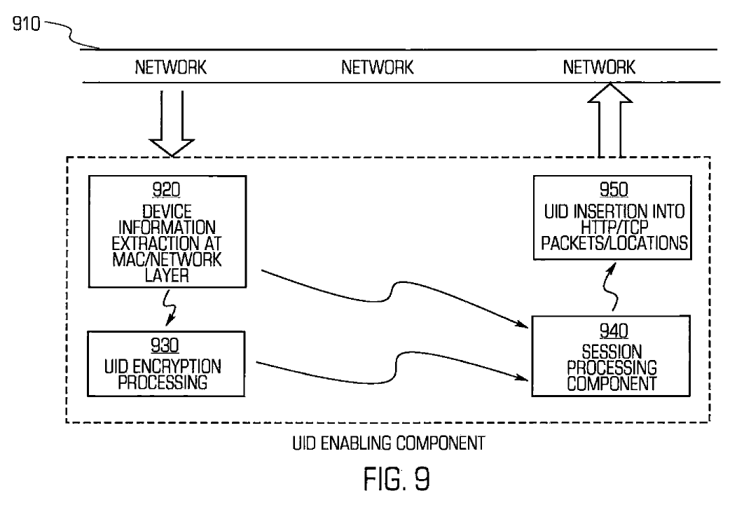

The identification element (hardware or software) may further process the triggers/messages received from the authentication elements, and GUID's to provide them as input to a Classification element as described in the current invention. The Classification element may use these inputs to perform classification of the User/User device based on the said inputs, and other generic anonymous data related to the geographic/demographic/psychographic footprint of the network operators subscriber base. Given that components of the inputs to the Classification element are data prevalent only at the Network Layer & MAC Layer of the OSI stack, they may be uniquely persistent relative to other identification methods used for selection/optimization and presentation of internet based content. The Classification element further processes these data to create the persistent & anonymous GUID's as detailed in the current invention. These GUID's may be numeric, alphabetical, special characters, and/or a combination of these basic types of identifiers. The length and number of characters maybe be variable. Aspects of the features set forth here and below are illustrated in FIGS. 8 and 9.

The implied learning(s)/lessons and the GUID accumulated by the Classification element are further transported to the Tagging & Markup element that may use these data for its own data processing requirements. The tagging & markup element takes the inputs from the classification element and uses those data as parameters to be inserted into to web-bound content/services seeking requests initiated by the user/user device. The insertion may be conducted on different types of protocols such as HTTP, TCP, SIP, VOIP, etc depending on the nature of the application environment. The insertion can be conducted at different (maybe even multiple) layers of the OSI stack implementation. The network based processing of these data and insertion processes makes the identification & classification of the user/user-device anonymous and persistent—when compared to cookies implemented at Layer 7/Application Layer, as used by existing web-serving technologies.

In the exemplary embodiment illustrated in FIG. 1, the Routing/Connectivity Device is comprised of a first RCD component 125A (e.g., an access point) and a second RCD component 125B (e.g., a gateway, first router, etc.), although the RCD may readily be implemented as a unitary or otherwise distributed system element(s).

The information stored in various system components such as user profile information may be updated over network 140 using information gathered by RCDs 125A and 125B from users 121 connecting with or attempting to connect to the network. In some embodiments the RCDs or routers may request user and device profile information from the various information-providing components if the particular user or device has accessed the system on a prior occasion. In some embodiments, user or device profile information may be downloaded to a local network cache (not shown) for quicker access. In some embodiments, according to the present invention, multiple routers and/or servers may be used and physically and geographically distributed across network 140. Network 140 could be a LAN, WAN or the Internet. Further, a request associated with the network may be associated with a user of an access device in that the request may either be an explicit instruction of the user or it may simply be the result of the user's innate access device functionality. In some embodiments, the RCD 125 could be consistent with existing access point (“AP”) systems such as remote wireless access points/servers from generic providers. In some embodiments, the present information processing system may also be used or implemented with wired technology. Embodiments of the present system may also include signal amplifiers, external antennas, signal splitters, and other standard equipment as components.

In some embodiments, the servers and related systems shown in FIG. 1 may be standard off-the-shelf components, routers and/or server class computing components. For example, a router of the present invention may be implemented with, e.g., a Cisco 6500 or 7600 Router, or comparable routers from other manufacturers, and the web server can be a MS IIS server. Additionally, any other programs or code capable of accessing and/or providing information in the database may also be used. In further embodiments, the system, servers, and/or system elements may use languages such as SQL, XML, SOAP, ASP, and HTTP, etc., to enable data transmission and processing, although any suitable programming language or tool could also be used.

Systems and methods of the present invention can be implemented on a variety of networks, including wireless networks such as WiFi, WiMAX, and any mobile Ethernet network. Systems and methods can also be implemented on wired and other networks, such as Cable, DSL and Fiber-based broadband networks, or any combinations of wired and wireless networks (e.g. combined Cable+WiFi). Certain embodiments of the present invention, as set forth herein, pertain to wireless/WiFi systems (not limited to varieties of WiFi 802.11b/a/g/n mobile Ethernet standards) and associated methods of information processing.

These embodiments collect and provide pertinent information about a user by virtue of collecting information about the access device associated with the user. Thus, the information is anonymous in the sense that it is not a profile of an individual per se, but rather information associated with a computing device they use. This information can be related to the device, the temporary or permanent software on the device, and any user-input data which is resident on the device. All these data are captured and retained, and indexed with an identifier, unique identifier (UID) such as MAC so the information from a repeat user can be verified and enhanced each time the same device accesses the network. While acquired information could be, for example, the full range of unrestricted information typically sought by commercial entities, aspects of the present innovations enable specific non-PII implementations consistent with prohibitions dictating that end user name, race, phone numbers, addresses, and other personally identifiable information are not collected/disclosed in adherence to restrictions or local laws, such as those directed to privacy and user trust.

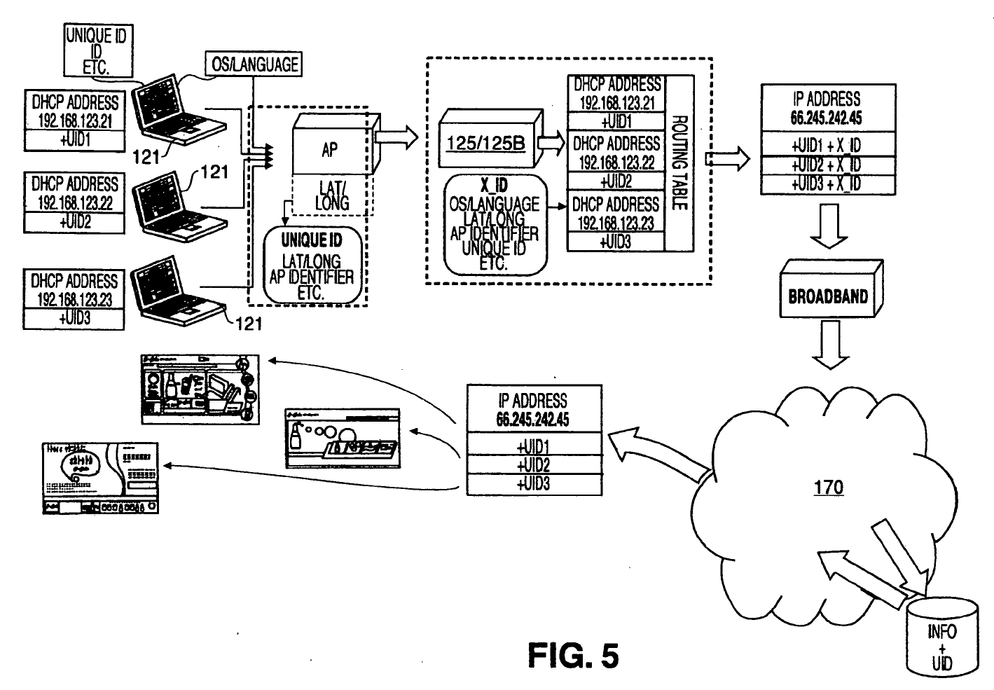

Embodiments of the system of FIG. 1 can also include a profile engine (not shown), which includes the ability to process unique identifier data and/or any other specific software- or hardware-based identifier. The profile engine may be a subcomponent of one of the components shown, although it may also be distributed anywhere within the system of FIG. 1. In one or more embodiments, the profile engine may include an algorithm designed to profile the identifier data/user based on the frequency and locations that the associated access device joins a network, coupled with other user data such as non-personal/device information. Such profile information can be correlated in the processor, weighted according to value (such as incremental numeric value), and then assigned for various additional processing purposes. For example, it can be placed in profile groups or pools to enable correlation with sponsors interested in that type or group of users. Pools are survey-related groupings, and are described in more detail in connection with FIG. 5, below. When a user requests to join the network, the identifier can be associated with a location tag, and the request associated with this information can be matched up with an appropriate sponsor for that location. Content highly targeted to the user is thereby enabled, including customized content from third-party databases that contain information related to the location. For example, the customized content may include information about the location itself, places, attractions, and events in the proximity of that location, as well as information related to what has happened and what will happen in that locality (e.g. historical events, future community or concert events, sale events planned at the local stores, etc.).

According to such further embodiments, such profile processing can provide highly relevant, targeted information, advertising or specific services that are unique to each user from the same network. Further, repeated access to the network by a user enables the profile engine to collect more and more network usage information for the user or associated access device. Additionally, the profile engine may also determine trend rates per geographic zone, which is of value to advertisers in the local region or remote sponsors seeking local presence. This can allow for local advertising, local billing of services, and the ability of nationwide advertisers and brands to customize their content according to a location or groups of locations with similar characteristics.

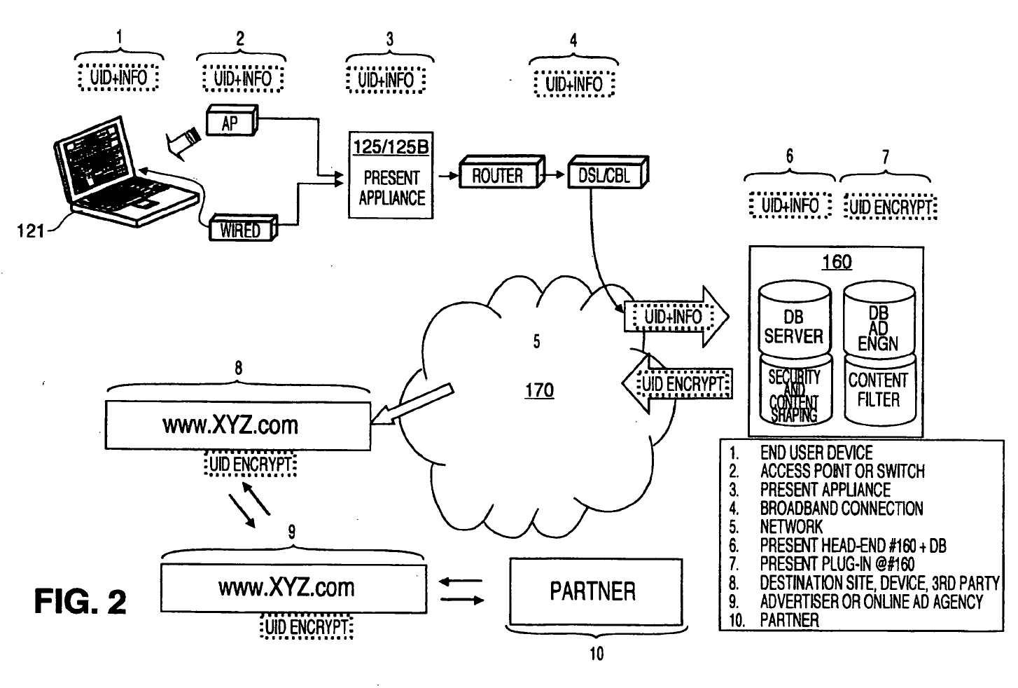

In some embodiments, user and/or device profile information received by a content server from either the RCD 125 or the router or network management component 120 may be used by the content server to determine which advertisements to retrieve from, e.g., an ad component. FIG. 2 illustrates one such representative architecture that illustrates exemplary targeted-advertising features, according to one or more embodiments of the present invention. The embodiment of FIG. 2 illustrates the interrelationships between some of the systems, sites, and entities associated with the targeted-advertising business methods and models disclosed herein. Specifically, FIG. 2 illustrates the basic architecture for information processing to and from these various system elements and entities.

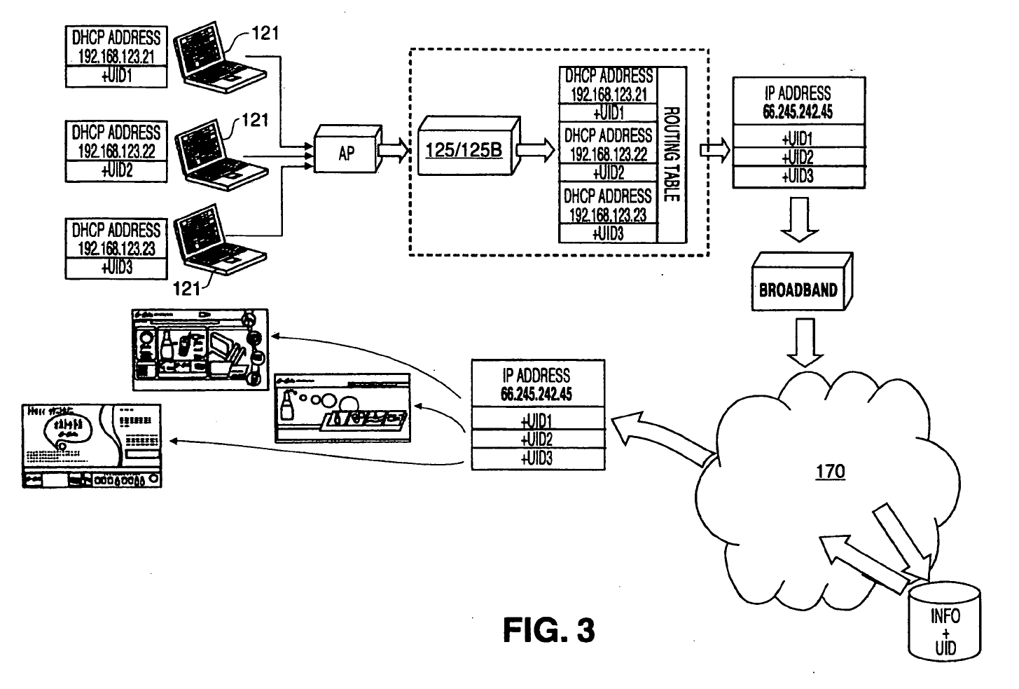

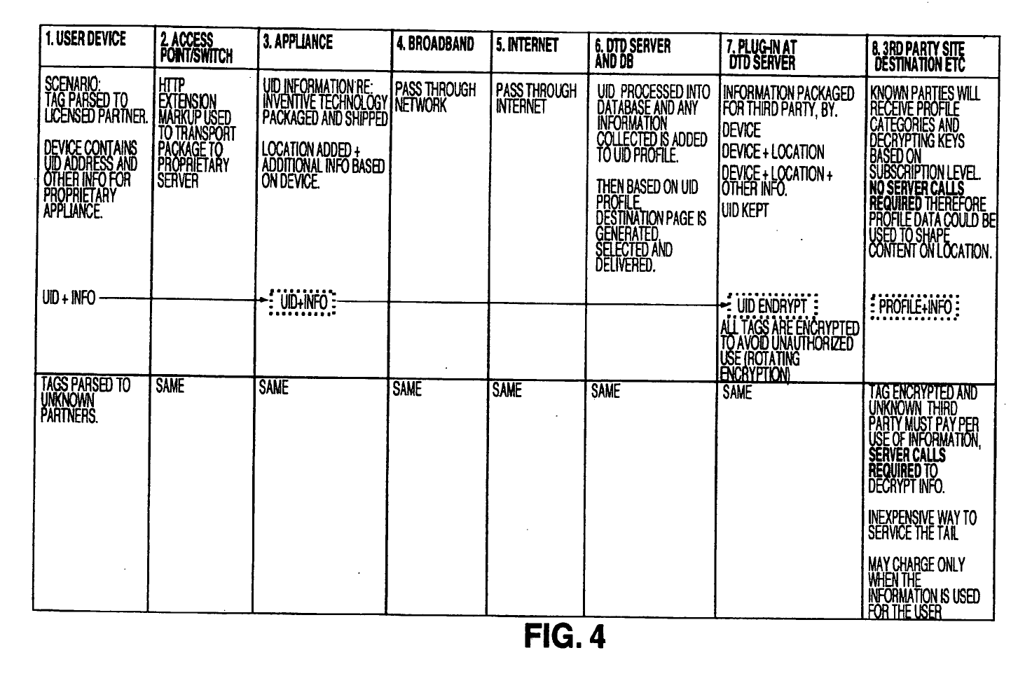

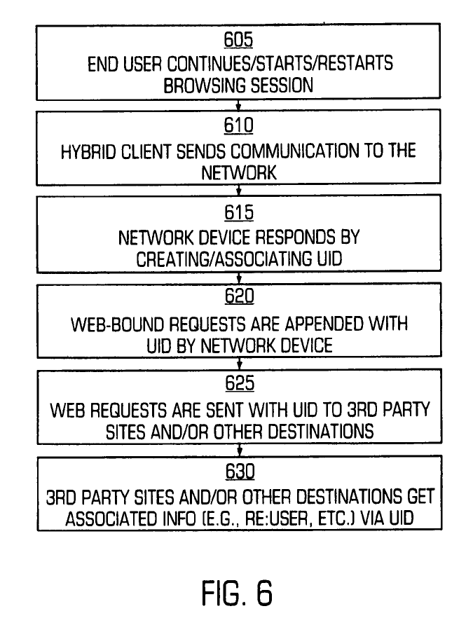

FIG. 3-4 are exemplary implementations of identifier or unique identifier information use throughout all phases of network processing and information delivery. By means of the technology of the present invention, identifier or unique identifier information such as MAC address is collected and transmitted to the DTD Server 160 and associated database(s) for processing and re-transmission. Some additional detail of these aspects are set forth below in association with FIG. 6. The systems, servers, and software of the present invention, in the sense of their anonymous user embodiments, can also readily access, use, and process MAC addresses that are not in a clear format without negative impact on the value they add to the network actors who desire the key pieces of data. Thus, MAC addresses that are encrypted, encoded, corrupted, or otherwise not in their proscribed format are handled equally as dynamically by the present system. For example, a unique identifier consistent with the less-than-clear MAC can be assigned, with all of the remaining data association and information processing steps remaining the same. Additionally, a key or basic data keyed to the unclear MAC can also be generated and used. Moreover, the present system and software can encrypt the outgoing unique identifier information such that others privy to such data transmissions have no way of reverse engineering the MAC address from the communications and protocols of the present invention.

Content and advertising information are combined by Content Server 130 and sent to the RCD 125 for transmission to the users 121. In some embodiments, the RCD 125 may modify the content or advertising received over the network 170 based on device characteristics. For example, FIG. 5 illustrates additional exemplary information processing and delivery, according to one or more embodiments of the present invention. FIG. 5 illustrates how identifiers, unique identifiers including the MAC address and other location- or device-specific information, are handled by one exemplary implementation of the present invention. The MAC address, however, is not the only location identifier available and used in the present invention. The system of the present invention can obtain LAT/LONG (latitude and longitude information), or this data can be parsed to the present system by certain current wireless mesh network systems, which is then incorporated into location processing algorithms. Other devices or data points associated with a user, such as other wireless or WiFi devices having an imprint on our network connection, can be assayed and their signal and location integrated into our location parsing (as well as all other information processing and delivery). Additionally, as shown in the upper left portion of FIG. 5, the operating system (“OS”) and preferred language of the device and/or user can also readily be collected with or without the MAC address. Similarly, if client 121 is a handheld device, the format of the content may be modified to better suit the screen and other characteristics of that handheld device.

Furthermore, the above-described systems may also include various system reporting features and functionality. For example, identifier information such as UID, MAC, etc. may be used to track a user as they travel from location to location, and an identifier algorithm engine may be used to process and provide other identifier-related information. According to these embodiments, the identifier algorithm engine can register the identifier in a database, including the time(s) of use, the AP (access point) location, and the user profile. Specific illustrations of this functionality are described below.

According to some global/system-wide aspects of the innovations herein, applicable throughout all stages of information processing and delivery (see, e.g., FIGS. 2-6, especially FIG. 4), UID and other information about the user/user-device is communicated to third-party web servers, one example of which is explained in connection with FIG. 6. When a user activates or re-activates a web browsing session 605 using hybrid/web-browsing software, the browsing software initiates communication with the network 610. Network elements, within the network, responsible for authentication & authorization perform their necessary functions and send a trigger/alert to network device (e.g, RCD, etc.). These triggers may or may not be delivered in real-time, and may contain parameters such as session state, session timeout, and/or user device identification information or some superset of such network data.

Based on these triggers, the network device (RCD) creates a UID for the given user/user-device for the given browsing session 615 based on several parameters; for example MAC-ID, location in the network, time of day, device type, etc. The UID may be further processed to protect from unauthorized use by unintended recipients. The encryption algorithm may be based on standard methods, or be a specialized embodiment of known methods adapted for maintaining highest levels of security. The decryption key and algorithms for deciphering the encrypted UID may be shared with the intended recipients. Parties that wish to use the UID may obtain the same decrypting methods through business relationships. Although encryption is important, it is not a necessary feature of this embodiment. At any given time, the network device may process several hundred or several thousand UID's based on the hardware and software configurations of the device.

Subsequently, when the user/user-device makes web-bound requests to obtain content and services, the network device appends the UID 620 to outgoing traffic. In this example, the process of appending the UID is performed by the network device. Certain features of the operation are similar to the workings of a HTTP-Proxy, such as being transparent to the user/user-device. The UID maybe appended at different layers depending on the protocols used for fetching the content/services. For example, the UID may be appended in the HTTP Headers of all out-going requests. It is important to note that the UID will be appended differently, and in different places based on the protocol of information exchange. The UID's may be intentionally appended in positions which make them easy to intercept at the recipient.

After appending the UID at the necessary stage, the network device forwards the requests onto the intended web-based destinations and/or service providers 625 to enable the process of information exchange. Consistent with this example, all traffic going through the network device now contains UID's. Web-based destinations, service providers and other 3^{rd} parties receive the traffic at standard interfaces used for serving web content, for example an Apache web-server. At this stage, the web-servers at the destinations may extract the UID from the incoming traffic using known processes. For example, if the UID is appended in the HTTP Headers, the extraction process is similar to determining the operating system, screen size and other information which is part of the HTTP Header set. Using the decryption methods intended recipients are now able to get information associated with the identifier 630, e.g., extract the UID and necessary information relevant to their use, make requests, for recipients who do not have the necessary decryption methods, for such information electronically to profile servers, or via third parties or other distributed means related thereto.

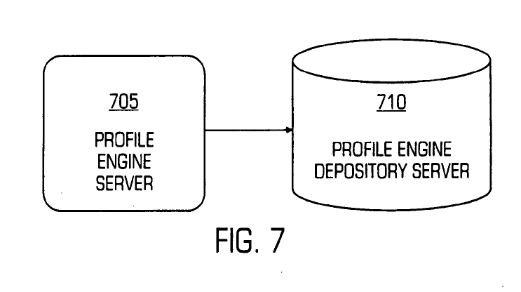

As shown in FIG. 7, a profile engine server may perform Profile Engine algorithms 705 on the data. The Profile Engine algorithms are based on a scaling value counter system, where value is given to every interaction of the identifier or MAC address (for example, a MAC address may be profiled on the number of times it has used the network, or it may be profiled by answered survey questions). As the Profile engine builds a profile using an identifier, it also places the information in associated bit buckets. Requests are then paired up with lose associated bit buckets and then mapped to sponsor advertisements profile(s). Finally, association of each sponsor is made to each location. The results are then stored in the Profile Engine Depository Server 710.

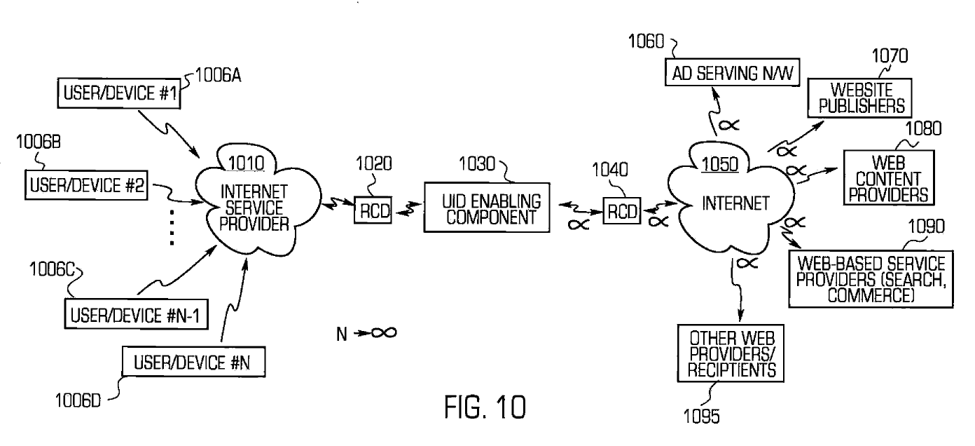

FIG. 10 depicts an embodiment of the current invention functioning on an internet service provider (ISP) network 310. As depicted, the network 310 provides internet connectivity services to a large pool of users/user devices 306A-306D. The number of such users/user-devices may vary from as little 1 to as many as infinite, thus the scope definition of “user/device # 1” through “user/device # N”. Based on the novelty of the current invention, as the users/user-device on such a ISP network seek internet based content, the RCD device 320 transmits these requests to the Internet 350 via the depicted apparatus. This intermediate apparatus may include, but is not limited to, the UID Enabling Component 330—described earlier in the invention disclosure, and an associated RCD 340. During the various stages of network processing performed by the UID Enabling Component 330, a persistent/anonymous UID is inserted into all outgoing web-destined requests. These requests may be made over protocols such as HTTP, HTTPS, VOIP, SIP, etc. The existence of these UID's during different stages of network processing is depicted by the “a” sign.

Consistent with such overall system processing, a method of processing information associated with web/network-related requests throughout all phases of network processing and information delivery is disclosed. An exemplary method, here, may comprise receiving a web/network-related request initiated via a device and/or a user associated with a device, wherein the request is appended with a unique identifier (UID) that is an anonymous identifier contained in the HTTP header or other extensible locations within the request, transmitting the UID to an information provider associated with the UID, and receiving profile/identification information regarding the device or the user via the information provider.

As illustrated by way of example in FIG. 10, beyond the processing performed at 330, the web-destined requests are forwarded onto the Internet 350, by existing network processing and routing protocols and equipment. Furthermore, as the requests appended with the UID's at stage 330, traverse the internetworking components of the Internet, they are delivered to their intended recipients—360, 370, 380, 390 and 395. These recipients such as Website Publishers 370, Advertisement Serving Networks 360, Web-based content providers 380, Web-based services providers 390, and other web-based recipients 395; receive these persistent UIDs at standard interfaces. Standard interfaces such as web-server front-ends and other such hardware & software processing components that they employ for the primary purposes of delivering their services. These recipients 360, 370, 380, 390, 395 may utilize the persistent UID's for the selection, optimization, and presentation of their services.

Consistent with one or more embodiments of the present invention, various methods of collecting and processing information may be performed. Turning back to some exemplary initial interactions, an end-user may first connect to a internet access network and launches a web browser. The browser is not allowed to access the default home page of the computing device, but rather is redirected to the DTD Server 160 over the network. Beginning with this very first handshake/data exchange whether through hypertext markup, radius accounting records, or back-channel communication, the DTD Server 160 acquires user profile and user identifier information, and begins saving this information to a database, this information can be new or simply building upon existing an existing profile. The profile protects user anonymity by using the UID as a proxy for the individual The information stored in the database may be, inter ala, time/date information, initial home and/or default page information, location information such as that derived from the server or access point IP address or ID, specific identifier information for the user (e.g., MAC address, etc.), additional information can be provided by third parties who wish exchange existing user/device information and/or store this third party information indexed by the UID for future transactional reference, as well as any other information acquired by the DTD Server 160 at this time. As a result of survey and profile engine processing (as detailed, inter alia, below), survey questions specific to each user are generated based upon the acquired information. DTD Server 160 then transmits first data such as a terms and conditions (T&C) page with these survey questions to the user. The user may then answer the survey questions and acknowledge the terms and conditions, for example, by selecting an “accept” button. In response to receipt of this acceptance, the DTD Server 160 can open or instruct the network equipment to open a network connection for the user. The DTD Server 160 also then stores the survey answers as well as any new or related user identifier information in a database. Additional processing related to this new (e.g., survey) information is performed by the DTD Server 160, as set forth herein. As a function of this additional processing, the DTD Server 160 opens up (or instructs network hardware to open) a client port on the local server and redirects the user to a splash page (also known as landing page) determined as a function of user identifier information with components customized for that individual. Suitable splash pages may be retrieved and stored in network cache. Finally, a local splash page, determined as a function of the access device location, is sent to the user's browser. Furthermore, all of the content transmitted to the user (e.g., first data, splash pages, etc.) may be formatted and/or indexed to the specific type of access device utilized by the user, as determined by the DTD Server 160. The cumulative profile generated by DTD can be accessed for future use during that session or sessions that follow.

In one exemplary process, the DTD Server 160 receives a request for the local Terms & Condition (T&C) Page from the end user. During these initial exchanges, the following exemplary information may be acquired by the DTD Server and recorded in the Profile Engine: identifier information such as end user MAC Address, Local IP Address, Default Home Page URL, RCD and/or Network Device ID, Network IP Address (e.g., for RCD, Network Device, etc.), Location ID, Local Language on Computer, Operating System/Device Specific Information, Nest Requested Home Page, Survey Results, Date and Time Information, as well as other information derived from the access device, the user's behavior, or information concerning the user generated at or by the RCD.

Next, the DTD Server checks against the DB to see if the identifier acquired has an existing profile (profile ID) associated with it. If there is no profile ID, then the identifier is added to the profile Engine and assigned a Profile ID. The location ID is then checked against the location profile database to see if the profile tag is set to on or off. The profile tag is set to “off” if the identified user has an existing profile and answers to all of the survey questions are on file. If the profile engine is in need of the answers to outstanding survey questions, the profile tag is set to “on.” If the profile tag is set to off, then a Local T & C page is forwarded to the requesting end user's browser.

Then, if the profile tag is set to on, the location T & C Page is matched up with the user profile ID as well as the required survey question(s), which are forwarded to the end user browser by instruction from the DTD Server. The end user would never see the same survey question asked across any location on the network, since DTD Server tracks the identifier throughout the network.

Next, first data such as a welcome page with Terms & Conditions (T & C) is transmitted to the end user. This return page is already formatted to the device type, screen size, and format, which is/are specifically tuned to the device's capabilities. The end user may then be asked to accept or decline the T & C page condition. If a survey question is also provided here, the user has to answer the question in order to move forward.

If the user clicks on the disagree button (regarding the T&C's), the user browser is redirected to a courtesy page requesting him or her to disconnect from the network. Alternately, a processing component may respond to a disagree selection by providing a less then full-service web experience. For example, a DTD Server may restrict the user's time or bandwidth on the network, or offer reduced guarantees of priority, traffic, and/or other performance characteristics as compared to those provided via acceptance of the terms and conditions. In some cases, these restrictions may be implemented by permitting basic web-browsing while blocking Virtual Private Networks, thus preventing a user, such as a corporate user, from accessing email or using other important features associated with such networks. Restrictions may also be implemented by introducing jitter and/or delay to the extent that VoIP performance and real-time streaming of video services are not feasible or satisfactory, though browsing the web is still possible.

If the user clicks on the Accept button, another request is sent to the DTD Server to activate a user's pending status to active status so they can now use the Internet freely. This is the unrestricted mode of using the access network, which allows the user to utilize all of the features and functionality of the Internet. However, access can still also be moderated by a pre-determined and/or real-time access control system. Such moderation or control may enable determination of the actual bandwidth and other performance characteristics contemplated. For instance, if certain identifiers have been pre-programmed within the network to restrict VPN access, then any policies of specific user access can be implemented at this stage. Next, a splash page is transmitted to the user and a connection is opened.

In further processing, the DTD Server may register the request and time of the request in an associated database. If the request includes responses to survey answers, then they are forwarded to the Profile Engine, and survey answers may be updated against data already stored for that user in the Profile Engine.

Here, the DTD Server now transmits some commands to the network device to activate the pending status, set the upload and download bandwidth speed per the identifier, and set an expiration time of when the user's session will expire for that network.

Next, the user's Location ID is checked to see if it has a sponsor associated with that location. If there is no sponsor a generic local splash page will be sent to the requesting user. If a sponsor is associated with that location ID based on the location profile database, a splash page with relevant local information, and a targeted advertisement based on the user's profile ID will be sent to the user.

Again, the profile engine server may perform the Profile Engine algorithms on the data. The Profile Engine algorithms are based on a scaling value counter system, where value is given to every interaction of the identifier or MAC address (for example, a MAC address may be profiled on the number of times it has used the network, or it may be profiled by answered survey questions). As the Profile engine builds a profile using an identifier, it also places the information in associated bit buckets. Requests are then paired up with lose associated bit buckets and then mapped to sponsor advertisements profile(s). Finally, association of each sponsor is made to each location. The results are then stored in the Profile Engine Depository Server.

Regarding, in particular, the wireless implementation addressed above, the present invention provides particular advantages pertaining to direct access, location, traffic and network operations. With respect to direct access, the present invention provides direct connection to the customer and eliminates third party involvement in the delivery of content, as well as allowing for the licensee/subscriber/vendor to be the starting point of each and every communication (e.g., page, flash page, search, etc.) with the customer. With respect to location, the present invention provides the exact location of the customer, providing significantly greater value to related advertising and information. In other words, the more granular the information is about the customer, the more valuable it is to the advertisers (e.g., for directed advertising and other communications). Alternately, a more generalized location may be provided for the customer, such as region, zip code, etc., to protect user anonymity. With respect to traffic considerations, the cost methodologies addressed herein provide for greater accessibility, as costs present a significant competitive barrier. Specifically, embodiments of the present inventive methodology can provide free access by users, rather than requiring some sort of direct revenue from the end-user (although there can be fees associated with each subscription). Thus, regarding the maximization of traffic, these embodiments are particularly advantageous for networks that are: (1) carrier class, (2) easy to log onto, and (3) ubiquitous. Finally, with respect to network operations, the present methodology provides relatively low equipment costs with respect to prior network access of this nature, as well as the capability of avoiding the expenses of otherwise implementing/managing a network of this quality.

The technology set forth herein has particular applicability to the operation of WiFi networks, and especially companies closely associated with WiFi technology. The systems and methods of the present invention provide numerous advantages in the areas of network management and operation, data collection and aggregation, real-time provision of user demographics, location and other information, and reporting of WiFi network usage (summaries, aggregates, even real-time). For example, the WiFi embodiments have specific applicability to service providers, portals, and internet ad intermediaries.

For example, these WiFi embodiments provide unique advantages to service providers like VoIP (voice over IP) internet telephony companies, such as authentication/authorization of the telephones on log-in, logging of the calls for statistics and billing, network management (e.g., bandwidth, ports, etc.), and security management (e.g., firewall, eliminating unwanted third parties, etc.). These WiFi embodiments also provide significant advantages to portals, such as real-time user demographics and location that allow for immediate, directed advertising. These WiFi embodiments also provide significant advantages to internet ad intermediaries, such as information management applicable to all of the many layers of service providers involved in having an ad (e.g., banner) displayed on a web page.

In another exemplary implementation, the present invention may help prevent click-fraud, or other activity of interest performed by users of the network. Here, the DTD server 160 has information about identifiers (such as MAC addresses) of every device on the network. This information can be associated with the cumulative number of clicks (on advertisements, marketing media etc), which can then be used to trigger a further audit if there is an anomalous number of clicks. This may allow an operator of the network, for example, to provide information about such anomalous behavior. This can be important, as the total number of clicks can be also traced to the number of clicks on a particular website and/or a particular advertisers advertisements or content. As a result, the invention can be used as both an alerting mechanism and then a tracing mechanism to monitor and prevent click-fraud. In addition, if it is required, access to the network can be blocked for the offending device based on its identifier, so the user cannot access the network and continue with fraudulent or non-compliant practices.

In a further exemplary implementation, the present invention may also provide benefit in the areas of security and access control. Again, since user identifiers (such as MAC address) are known in the network, they can be mapped into dynamic databases which are used as a secondary mechanism of physical machine verification for access to networks, websites, and/or specific classes of digital content on a network or networks. Since the DTD Server has a database of all devices, it can interface with a large number of third-party databases. For example, it can interface with databases of allowed users who have high priority for access to the network in case of an emergency response situation, such as one directed, for example, to the whole network or just to a specific geographic location. Therefore, multiple classes of access, rules, syntax, and associations of such databases are done inside the DTD Server, enabling the network to develop intelligent rules for access to services and content based on unique combinations of these databases, and apply them to the identifier of the device.

In yet another exemplary implementation, the present invention may also provide benefit in the area of rule-based blocking of content. Specifically, the DTD Server may be employed to ensure that “no” content is delivered when none is desired. This functionality may be applicable, for example, when a network TV broadcast is scheduled for particular show times in certain regions in the world, or when movies and other digital content, such as music, are released in a carefully controlled fashion in a network. By having rules associated with content of this type, the DTD Server can determine if the user has the rights to receive and play the appropriate content. Such rights not being based solely on traditional DRM techniques, but rather on the time, location, and other parameters that the content provider can specify. For example, if an online program is released in Australia, with a release time scheduled hours later in New York, then the content provider can tag the content such that it cannot be downloaded and/or played until the appropriate release time determined by the content creator/distributor. Utilization of specific user identifiers ensures a layer of digital rights management enforceable via the network by association of the identifier and the DTD Server, by virtue of database interfaces, with the content rights and rules to be enforced by the content distributor.

Appendix A is incorporation here by reference in its entirety.

Other embodiments of the invention will be apparent to those skilled in the art from consideration of the specification and practice of the invention disclosed herein. It is intended that the specification and examples be considered as exemplary only, with a true scope and spirit of the invention being indicated by the disclosure above in combination with the following paragraphs describing the scope of one or more embodiments of the following invention.

We claim:

1. A method of generating a global unique identifier (GUID) associated with web/network-related requests, the method comprising:
in the context of processing a web-bound request associated with a browsing session, receiving information associated with a device that initiated a web-bound request;
extracting non-personal/device information during MAC/network layer processing, wherein the non-personal/device information includes one or more of data associated with a device/user, data related to the device, software on the device, or any user/input data that is resident on the device; and
creating an anonymous GUID based on the “non-personal/device information”;
wherein global persistence of the GUID is enabled as a function of extraction of non-personal/device data during MAC/network layer processing.

2. The method of claim 1, wherein non-personal/device information includes the device's hardware address.

3. The method of claim 1 further comprising storing the anonymous GUID in a central depository.

4. The method of claim 3, wherein the central depository further comprises an interface for updating the non-personal/device information.

5. The method of claim 3, wherein the central depository further comprises a customer authentication element.

6. The method of claim 1 further comprising storing the anonymous GUID in a distributed depository.

7. The method of claim 5, wherein the distributed depository further comprises an interface for updating the non-personal/device information.

8. The method of claim 3, wherein the distributed depository further comprises a customer authentication element.

9. A method of inserting a network-related unique identifier (UID) to a web-bound request, the method comprising:
in the context of processing a web-bound request associated with a browsing session, extracting non-personal/device information during MAC/network layer processing;
processing an anonymous UID generated based on the non-personal/device information; and
inserting the anonymous UID in the HTTP header or other extensible locations within the web-bound request;
wherein global persistence of the UID is enabled as a function of extraction of non-personal/device data during MAC/network layer processing.

10. The method of claim 9, wherein non-personal/device data includes geographic data.

11. The method of claim 9, wherein non-personal/device data includes demographic data.

12. The method of claim 9, wherein non-personal/device data includes psychographic data.

13. The method of claim 9, wherein non-personal/device data includes behavioral attributes.

14. A method of processing information associated with web/network-related requests, the method comprising:
receiving a web/network-related request initiated via a device and/or a user associated with a device, wherein the request is appended with a unique identifier (UID) that is an anonymous identifier contained in the HTTP header or other extensible locations within the request;
transmitting the UID to an information provider associated with the UID; and
receiving profile/identification information regarding the device or the user via the information provider;
wherein global persistence of the UID and anonymity of the profile/identification information received are enabled as a function of extraction of non-personal/device data during MAC/network layer processing.

15. The method of claim 14, wherein the profile/identification information is stored in a central depository.

16. The method of claim 15, wherein the profile/identification information is received via an interface distinct from the central depository.

17. The method of claim 14, wherein the profile/identification information is stored in a distributed depository.

18. The method of claim 17, wherein the profile/identification information is received via an interface distinct from the distributed depository.
